(19) United States
(12) Patent Application Publication
(10) Pub. No.: US 2024/0086726 A1
(43) Pub. Date: Mar. 14, 2024

(54) SYSTEMS AND METHODS FOR BIG DATA ANALYTICS

(71) Applicant: NEW ENGLANG COMPLEX SYSTEMS INSTITUTE, Newton, MA (US)

(72) Inventors: Yaneer BAR-YAM, Newton, MA (US); Olga BUCHEL, Chelsea, MA (US); Leila HEDAYATIFAR, Boston, MA (US); Amir Akhavan MASOUMI, Bedford, MA (US); Alfredo MORALES, Somerville, MA (US); Chen SHEN, Malden, MA (US)

(21) Appl. No.: 17/767,853

(22) PCT Filed: Oct. 8, 2020
(86) PCT No.: PCT/US2020/054856

§ 371 Date: Apr. 8, 2022

Related U.S. Application Data
(60) Provisional application No. 62/912,288, filed on Oct. 8, 2019.

(51) Int. Cl. G06N 5/022

(52) U.S. Cl. CPC G06N 5/022

(57) ABSTRACT

Systems and methods perform analytics and visualization of Big Data. A multiscale geosocial network apparatus can be used for identifying prospective customers and communities of customers with shared interests. A model and visualization of customer signatures for analyzing trends in customer behaviors and making long-term forecasts about future customer activities. An analytics and visualization tool is presented for inventory management using comprehensive event analysis. A set of methods for optimizing shipping and storage costs uses historical data from a variety of data sources including social media platforms and business records of a corporation. The system and method take, as input, data and transform that data into insights that can provide guidance for a variety of decisions including new customer acquisition, managing customer portfolios, inventory management, and optimization of logistics as well as strategic business decisions and planning.

### FIELD OF THE INVENTION

This invention relates to data analytics and visualization methods to improve decision making of individuals in for profit corporations and other organizations. In particular it develops systems and methods for analyzing corporate, public and other data sets for improved marketing, customer relations management, as well as optimizing supply chains, inventory, shipping, production and internal communications. The approach of the invention falls within the general domain of decision support systems, unsupervised learning methods, and artificial intelligence (AI).

### BACKGROUND OF THE INVENTION

The analysis of data from internal corporate, public and other sources is increasingly central to business functions including marketing and customer relations management as well as optimizing supply chains, inventory, shipping, and production. There are many traditional and new sources of data that are becoming available for data analysis. Among the data sources are census data, social media data, internal inventory data, and customer order records. The primary challenge in the use of data is extracting meaningful insights that can be used to improve both tactical decisions associated with individual customers and individual products, and strategic decisions about corporate policies and direction.

Improved analytic methods can be used to develop improved predictions of the behavior of potential and current customers, supply chain properties, and for optimizing income and costs. Among the opportunities are improved targeting of potential customers through more accurate marketing personas, a better understanding of the regional differences in customer behavior, and identifying the best locations for customer-facing outlets and services as well as production facilities and warehouses. For example, characterizing customer behavior more effectively can improve the selection of where and when to advertise, what messages to use in advertising, and thus to improve efficiencies in advertising budgets, as well as provide guidance on where to open new stores and what products to sell in those stores, together increasing revenue and decreasing costs.

Existing methods of analyzing data depend on simplifying assumptions about human behavior, customer dynamics and industrial processes. As one example, marketers often employ generic personas for groups of people; these personas are determined through either human insight or from statistical methods applied to data with simplifying statistical averages and other approximations. As another example, supply-chain management practices for responding to customer demand have gravitated towards information-based systems that rely on computer inventory records to inform critical decisions and daily operations. The effectiveness of these tools hinges on the accuracy of the information, but the accuracy of these records has been shown to be very poor precisely for stockouts which are essential to effective inventory optimization.

Advances in analytic methods have been developed to address a variety of limitations in methods. These advances continue to have deficiencies that limit their utility or accuracy for important corporate applications. In general, the prior art does not provide advertisers and marketers with a comprehensive understanding of customer behavior. It also does not provide for effective decision making about supply chain management functions including inventory, shipping and customer satisfaction.

More specifically, the response of consumers to marketing campaigns depends on how the messages are received by potential and current customers. The prior art does not sufficiently characterize the way people respond through the distinctions among individuals and groups of people. An overly simplistic understanding of user behavior will frequently produce mistargeted and ineffective ads. Customer relations management depends on knowledge of customer loyalty and future ordering potential. The prior art does not sufficiently characterize customer ordering behavior and loyalty leading to ineffective customer relations management and over- or under-production of goods. To optimize the business cost the shipping and warehouse networks for individual customers should be optimized. The locations of the new warehouses should be optimally chosen. Optimizing the inventory levels are important in reducing building and storage costs and ordering times. The lower costs enable lower final product prices and improved availability increases customer satisfaction which is an important factor in business competition. The prior art does not provide widely implementable robust supply chain cost optimization.

Recent efforts to better understand the online and offline interactions among people include studies of large-scale datasets obtained from communication or transaction records for landlines, mobile phones, social media and banknote circulation and have analysed the structure of mobility or communication networks separately, although the two are not independent from one another. Conventional as well as recently developed approaches to analysis of human behavior such as those explained above suffer from a variety of deficiencies. There is a need for a more robust and dynamic understanding of social group formation. More generally, there is a need to be able to extract patterns of human behavior from large bodies of data.

Similarly, conventional methods for characterizing customer ordering behavior for prediction of future demand have limitations. Among the deficiencies are a lack of precision and an inability to capture dynamic changes of customer behavior. The majority of existing methods are designed to make short-term predictions without showing how long a customer will continue to make orders. A few methods that can predict long-term behaviors are often skewed because customers with missing data are often excluded from the analysis. And they do not extrapolate effectively beyond the range of the observed data. There is a need for a more holistic understanding of ordering behaviors at the individual and collective level. Specifically, there is a need to be able to extract patterns of human behavior from a large number of orders.

Similarly, conventional methods for characterizing inventory have deficiencies, as computer records and physical inventory are seldom aligned, producing widespread errors. These methods depend on the use of events along with episodic corrections by cycle counts and physical counts for calculation of the inventory level at any time. Traditional approaches often use statistical methods for holding a margin of excess material to avoid possible stockouts, and do not particularly aim to prevent errors but rather focus on providing rapid estimates of quantity and time to initiate an order. A central limitation of conventional methods is in their inability to identify the sources of the persistent errors, and inability to calculate accurately demand rates after removing the discrepancies in the data, which accordingly leads to extra costs due to excess inventory or inability to fulfill orders.

Similarly, conventional methods for characterizing the optimal location of warehouses and shipping routes are limited in their ability to achieve optimal solutions. Among their deficiencies are brittleness of the solution and high cost and effort to implement in real world contexts.

### SUMMARY OF THE INVENTION

Embodiments of the invention significantly overcome the deficiencies outlined above, and provide systems, methods, mechanisms and techniques whereby (1) improved accuracy of prospective customer behaviors are extracted from social media datasets, (2) improved accuracy of predicted dynamics of existing customer behavior is obtained from ordering records, (3) improved accuracy for dynamic inventory data is obtained from corporate databases, and (4) improved accuracy for costs optimization of shipping is obtained from corporate databases. These examples are embodiments of methods that provide a general ability to analyze data and extract important insights into data with implications for various corporate processes including, but not limited to, customer personas, purchasing behavior, supply chain efficiencies, inventory management, and shipping.

The invention includes methods that apply processes to data to obtain information for decision making, include data-driven methods, model-driven methods, and data-driven modeling methods. A variety of related methods can be naturally inferred from these three cases consisting of parts, combinations and composites of these methods.

One embodiment of the invention includes methods, termed data-driven methods, which consist of the steps of: obtaining possibly large amounts of data, sometimes termed “big data,” that are relevant to a system that is of interest; pre-processing and organizing the data so that it takes the form of well structured data; mapping the data onto a variety of measures by a set of analytic processes, the measures produced by the analytic processes being characteristic of the structure and dynamics of the system that is of interest at different scales; applying additional analytic processes to the resulting measures to identify business related features of the system of interest; applying various algorithms and computer programs to visualize the results in the form of summary graphs, plots, charts, and movies; and building interactive visualization platforms to capture the essential information and make it observable to business owners, executives, operational managers and other employees and stakeholders of the corporation.

Another embodiment of the invention, termed model-driven methods, includes methods that consist of the steps of: developing algorithms that model, simulate or run algorithms that construct representations that are relevant to a system that is of interest, these algorithms having adjustable parameters and producing outputs; obtaining measures from the algorithm outputs that in part characterize the system; extracting relevant data from databases about the system; applying data associated algorithms that determine measures that characterize the system from the extracted data; adjusting parameters of the algorithms so that measures of the system optimally fit data measures obtained about the system; extracting the output from the algorithms after adjusting the algorithm parameters; applying additional analytic processes to the resulting output to identify business related features of the system of interest; applying various algorithms and computer programs to visualize the results in the form of summary graphs, plots, charts, and movies; and building interactive visualization platforms that capture the essential business related information and make it observable to business owners, executives, operational managers and other employees and stakeholders of the corporation.

Another embodiment of the invention, termed data-driven modeling methods, includes the steps of: obtaining possibly large amounts of data, sometimes termed “big data,” that are relevant to a system that is of interest; pre-processing and organizing the data so that it takes the form of well structured data; mapping the data onto a variety of measures by a set of analytic processes, the measures produced by the analytic processes being characteristic of the structure and dynamics of the system that is of interest at different scales; developing algorithms that input the measures produced by the analytic processes into algorithms that model, simulate or run algorithms that construct representations that are relevant to a system that is of interest, these algorithms having adjustable parameters and producing outputs; obtaining measures from the algorithm outputs that in part characterize the system; extracting relevant data from databases about the system; applying data associated algorithms that determine measures that characterize the system from the extracted data; adjusting parameters of the algorithms so that measures of the system optimally fit data measures obtained about the system; extracting the output from the algorithms after adjusting the algorithm parameters; applying additional analytic processes to the resulting output to identify business related features of the system of interest; applying various algorithms and computer programs to visualize the results in the form of summary graphs, plots, charts, and movies; and building interactive visualization platforms that capture the essential business related information and make it observable to business owners, executives, operational managers and other employees and stakeholders of the corporation.

An approach of the invention makes use of a process including dimension reduction to determine a parameter space, and determine the locations of elements of a system or instances of the system in the parameter space, which represents the important differences and similarities between elements of a system, or instances of the system. These differences are identified by algorithmic mapping of proximity between points in the parameter space, or the determination of distinct regions of the parameter space associated with distinct properties. The distinct regions of the parameter space being subsequently used to identify the properties of new elements of the system, or new instances of the system.

An approach of the invention makes use of a process to characterize the difference between data records representing system elements or instances of a system by assigning them as one of a set of types representing types of system elements making use of dimensional reduction to partition the behavior of the system without a predetermined definition of those types, including such categories as normal and abnormal events, or between a variety of distinctly labeled categories. Unlike the prior art of general unsupervised learning algorithms that partition pre-specified data sets, embodiments of the invention consist of systems and methods that partition the low dimensional space itself, so as to enable characterization of events that take place in the future as well as intermediate cases between normal and adverse, or between a variety of distinctly labeled categories, that enable characterizing vulnerability and provide information about how to change the system to prevent adverse events. In each case, characterization does not require prior events that are very similar to the new event.

An approach of the invention is to provide a method, the General Method, that can be used to generate a characterization scheme for any data stream. The generated characterization scheme may underpin another method, the Specific Method, which may perform a characterization of behavioral types, events, populations, devices, and the like, in a particular system, or multiple systems. The specific method for characterization may be incorporated in a computing device for execution of the characterization of events of a specific system, or multiple systems, into behavioral types.

An approach of the invention is to provide a method that identifies elements of the system or instances of the system for distinct automated or manual action based upon the location of their representation in a reduced dimensional space.

An approach of the invention is to construct or use a universal mathematical characterization of the behavior of individual events, elements of the system or instances of the system, the universal mathematical characterization being a dimensional reduction of the complete data vectors or analytic descriptions of the individual events, elements of the system or instances of the system, onto a few parameters that capture essential behavioral differences, these differences being relevant to the identification of actions by an individual or corporation that is making use of the method, the actions being either automated or manual, the identification of the action being understood from a visualization, equation, report or prompt resulting from a General Method or directly given by a Specific Method of the invention. Additional information is found in Document 10.

An approach of the invention is to recommend actions to be taken by an individual or corporation that is making use of the method, the actions being either automated or mammal, the identification of the action being understood from a visualization, equation, report or prompt resulting from the application of a general method or given by a specific method of the invention.

An approach of the invention is to construct or use a universal mathematical characterization of the behavior of individual events, elements of the system or instances of the system, the universal mathematical characterization being a dimensional reduction of the complete data vectors in a data driven method or analytic descriptions in a modeling approach of the individual events, elements of the system or instances of the system, the dimensional reduction mapping the data vectors or analytic descriptions onto a smaller number of parameters that capture essential behavioral differences, these parameters being components of a parameter space, the parameter space being divided into regions that identify types of behavior, the differences between the types of behavior being relevant to the identification of actions by an individual or corporation that is making use of the method, the actions being either automated or manual, the identification of the action being understood from a visualization, equation, report or prompt resulting from the application of a general method or given by a specific method of the invention.

In an embodiment of the invention, the data stream contains at least one of several types of data or metadata including but not limited to geo-located social media posts, electronic inventory records, supply chain costs, such as warehouse and shipping costs, shipping times, and historical customer ordering data.

The invention will be disclosed as solutions to the limitations of preexisting methods in the following sections.

### DETAILED DESCRIPTION OF THE EMBODIMENTS

Embodiments of the invention provide multiple processes including, but not limited to: obtaining big data related to a system of interest, pre-processing and organizing data in a structured form that is effective and efficient for analysis, constructing representations of the data that capture aspects of individual elements of the system through a dimensional reduction process, constructing representations that capture aspects of the behavior of the system of interest through a dimensional reduction process, constructing a parameterization of the resulting dimensionally reduced spaces, constructing a partition of the dimensionally reduced space, constructing a labeling of the regions of the partition of the dimensionally reduced space, constructing a visualization of the dimensionally reduced space, constructing an interactive visualization platform of the dimensionally reduced space and the behavior of individual elements of the system and the behavior of the system of interest, mapping the labeled regions of the dimensionally reduced space onto recommended actions of individuals or corporations.

### Part I: Embodiment on the Topic of Prospective Customers

An approach of the invention is to determine signatures, characteristics and behaviors of potential customers or users from large data sets using algorithms, data-analysis, and a visualization system. A specific embodiment characterizes fragmentation within social networks of social media users as well as segmentation of customers with distinct buying patterns. The result of the method includes actionable strategies for marketing and a visualization system that visually presents patterns characterising potential customers and juxtaposes different aspects of the potential customer behaviors, allowing for novel insights. Unlike the prior art, this process does not rely on preexisting assumptions about human behaviors, instead extracting the characteristics of prospective customers and target audiences organically from the data.

An approach of an embodiment of the invention is to combine multiple processes including obtaining big data related to a social system of interest, preprocessing and organizing the data in a structured form that is effective and efficient for analysis, constructing mobility and communication networks that describe the social system from the data, detecting communities in the networks describe the social system at multiple scales, comparing the community patterns of the mobility and communication networks, extracting of hashtag usage patterns of users, and constructing a simulation model to define the effective parameters of the dynamics that can reproduce the properties of the social communities that are found in the data.

An approach of an embodiment of the invention makes use of geo-located Twitter data to generate networks of mobility, communication and patterns of hashtag use and explores how social interaction, communication, and behavioral networks fragment at multiple scales. Once identified, the resulting social fragments can be differently targeted in marketing and sales efforts as well as hiring campaigns and other business processes, based upon their distinct behavioral attributes including their relationships to others and interactions through the networks.

An approach of an embodiment of the invention uses a model of network growth that incorporates the properties of geographical distance gravity, preferential attachment, and spatial growth and successfully replicates statistical properties of the social fragmentation patterns observed in the data. Among other outcomes, the invention shows that the structure of emergent real world social networks is richer than what distance alone can explain and includes the influence of factors like administrative borders and urban structures. This method relates geographical distance, population structure and other social properties to social interactions and fragmentation, identifying how to better target potential customers given their relationships through the network of interaction, and the geographical social and commercial factors that are relevant to commercial interactions.

An approach of an embodiment of the invention is to construct networks describing where people travel and with whom they communicate from geo-located Twitter data. The data are obtained using the Twitter Streaming Application Programming Interface (API). A large number of tweets are obtained to extract a reliable characterization of the network structures. Details of this embodiment are presented in the incorporated Document 1, in which over 50 million tweets sent in December 2013 from all around the globe are collected. Further details of this embodiment are presented in the incorporated Document 2, in which over 87 million tweets posted by over 2.8 million users are collected from Aug. 22, 2013, to Dec. 25, 2013, in the US.

In the networks created in these embodiments of the invention, nodes represent a lattice of 0.1° latitude×0.1° longitude cells are overlaid on a map of the earth. Each cell is approximately 10 km wide. Network edges reflect two types of data: mobility and communication. In the mobility network, edges are created when a user u tweets consecutively from two locations, i and j. In the communication network, edges are created when a user u at location i mentions another user e that has most recently tweeted at location j. The weight of an edge represents the number of people who either travel or communicate between i and j. These networks aggregate the heterogeneity of human activities in a large-scale representation of social collective behaviors.

The term ?social fragmentation? in this embodiment represents the modular structure of a social system due to the relative absence of links and nodes between the fragments as compared to those within it as measured by modularity detection algorithms. Many algorithms can be used to represent modularity. In this embodiment, social fragmentation is analyzed by applying the Louvain community detection algorithm with modularity optimization. This algorithm initially considers each node as a single community and maximizes the metric modularity. The highest value of the modularity (ideally above 0.3) shows optimal partitions of the network, see FIGS. 1 and 2 in Document 2 and FIGS. 3 and 6 in Document 1. In order to determine the robustness and business relevance of the resulting modular structures, the modular structure of the mobility and communication networks was compared by constructing a matrix counting the number of overlapping nodes of communities arising from the networks of communication and mobility. See FIG. 3 in Document 2.

Communities were further determined at multiple scales by applying a generalized version of the modularity optimization algorithm, which controls for the coarseness of the communities with a resolution parameter γ. The conventional modularity equation uses γ=1. If γ<1 larger communities are prevalent. If γ>1 smaller communities appear. As Louvain algorithm has multiple maxima, we choose partitions that are robust to multiple runs of the algorithm, see FIGS. 4 and 5 in Document 2. We compare the partitions in mobility and communication networks for different values of γ by using three measures of cluster similarity: Purity, Adjusted Rand Index and Fowlkes-Mallows Index. These measures evaluate the overlap of partitions, with values ranging between 0 (no intersection) and 1 (perfect match), see FIG. 6 in Document 2.

The embodiment further validates the significance of the patches for business and identifies behavioral attributes of their members for marketing and other purposes, by clustering hashtags. We create a matrix whose rows represent locations on the map and columns represent hashtags. In order to observe collective behaviors, the embodiment accounts only for those hashtags that were posted at least 500 times and locations with at least 20 tweets. The term frequency-inverse document frequency (TF-IDF) transformation was applied to the matrices in order to normalize the hashtags (columns of the matrix). We then apply principal component analysis (PCA) to the hashtag matrix and retrieve the top 100 components, and then apply t-distributed stochastic neighbour embedding to the resulting PCA matrix. Locations from the same community show similarity in hashtag use and divergence with locations from different communities for either the mobility or communication networks, see FIG. 7 in Document 2.

In another embodiment of the invention a network growth model is constructed and the parameters of that model fitted by comparison with the social fragmentation networks obtained from Twitter data in order to determine the properties of social fragments for marketing purposes. The model combines geographical distance gravity and preferential attachment to allow creation of hubs (cities), and spatial growth to allow the growth of urban areas. We begin with a lattice representing geographical locations, and grow connections among them simulating the way people travel or communicate. The probability of creating an edge between locations i and j in each time step is

$${P}_{ij} \sim {〈 {k}_{nn} 〉}_{i}^{ν} \frac{{k}_{j}^{α}}{{d}_{ij}^{β}} . \qquad ( 1 )$$

Where i represents the origin of the interaction, j indicates the destination, <kₙₙ>ᵢ indicates i's nearest neighbors' average degree, kⱼ represents j's degree, and dᵢⱼ represents the distance between i and j. The exponents α or, β and ν control the effects of the preferential attachment mechanism, geographical distance gravity and spatial growth, respectively. Fitting the parameters of the modeled growth describes geographical clusters similar to cities (ν), their degree of attractiveness (α) and the linkage between urban centers and surrounding areas, including neighboring cities (β). Fitting model parameters results in system measures that accurately represent the data derived measures.

Simulations start with a random seed of three connected locations. Each location in the lattice has 4 nearest neighbors, except for locations in corners and on edges, which have 2 and 3 neighbors, respectively. Links are undirected and weighted to represent the iteration of links over time. Origins are picked randomly (independent from destinations) if their normalized value of <kₙₙ>^{ν} exceeds a random threshold. To allow all the locations in the lattice to participate in the dynamics, for the first N time steps, we turn off the origin priority selection and let the system choose origins from a random order of locations, where N represents the number of locations. The probability of selecting destinations is a combination of the preferential attachment mechanism and geographical distance gravity as shown in Equation ??. Thus, locations that are nearer to the origin location and have a higher degree have a higher probability to be chosen. Simulations continue until reaching a stable state in which communities form and do not change in number. Spatial fragmentation arises when the gravity mechanism is stronger than the preferential attachment (β>α), either without hubs (α=0) or with hubs (α>0). Increasing ν leads to more localized high-activity areas (cities), but this also destroys localized patches, leading to lower values of modularity, see FIGS. 8 and S9 of Document 2. We applied the Kolmogorov-Smirnov statistical test (K-S) to compare the average degree distribution from the model realizations to that of the mobility network, and similarly for the communication network, see FIGS. 9, S10 and S11 in Document 2.

An approach of the invention makes use of a characterization of the fragmentation of society into geographic groups by further constructing a labeling of the geographic regions. The geographic labeling comprising a dimensional reduction of attributes of individuals of the population. The labeling may be into distinct regions, more generally it may be a partial hierarchy of labels in small regions embedded into larger and larger regions, the partial hierarchy providing labels of progressive refinement for the characteristics of individuals that are members of the hierarchically organized groups. The existence of some changes in regions may lead the embedding not to be a pure hierarchy, hence it is termed a partial hierarchy, as smaller groups may shift between larger groups as the characterization of groups changes, just as in a reporting hierarchy in an organization for some cases an individual may report to multiple bosses. Labels may be further identified by the multiple attributes of the groups, including mobility group, communication group, topic group, and other associated attributes such as the nature of the topic that dominates discussion within that group, or the set of topics dominating conversation in that group. Other labels from demographic, economic, census, or other sources may be added as additional labels.

An approach of the invention makes use of a labeling obtained from an analysis of social fragmentation, this labeling being a dimensional reduction labeling according to geographic regions, the differences between the labels being indicators of types of behavior that are relevant to the identification of actions by an individual or corporation that is making use of the method, the actions being either automated or manual, the identification of the action being understood from a visualization, equation, report or prompt resulting from the application of a General Method or given by a Specific Method of the invention.

### Part II: Embodiment on the Topic of Existing Customers

In an embodiment of the invention, a method for analyzing complex customer behavior is applied to historical customer order records. The invention provides insight into complex customer purchasing behavior. The complexity is associated with customer ordering behavior and their decisions to order or not to order from a particular company. Customers make individual orders, and they more generally begin to place orders with a particular company and stop orders at a later time without resuming orders in the future. This behavior may be termed “enter” and “leave” the customer population. Customers do not generally provide information about their ordering intentions. This complexity of customer behavior for individual customers also increases the complexity of the entire system of customers in aggregate for a particular company. The lack of predictability of customer behavior affects company strategy as it has to make decisions about ordering of raw materials and production of a wide range of products. Insights into both individual and collective customer ordering behavior and the ability to predict probabilistic but quantitative estimates of which customers will leave and which will not, or the amounts and duration of individual or aggregate customer ordering, provides companies with improved reliability and optimization of decision making and competitive advantages.

In conventional customer ordering analysis, conventional algorithms only predict the short term behavior of the customers (from several days to 2-3 months). These predictions are of limited utility in informing tactical and strategic decisions of the company.

Embodiments of the invention use order number, time of individual orders, number of orders, volume of individual orders, or other properties of the ordering history of customers. Embodiments of the invention predict both the time a customer will leave and their total amount of activity. The predictions can be much more accurate than estimates available from prior methods.

In a particular embodiment the method uses the time and the number of orders for each customer. Orders of each customer are further grouped by month to construct ordering time series. Each customer ordering time series is adjusted to have the same length, from the beginning of company activities and ending with the most recent month. To do so, each customer ordering array is augmented by zeros prior to the time the first order occurred and following the period between the last recorded order until the most recent month. A cumulative time series is constructed for each of the customers.

The method further includes the step of fitting a sigmoidal function to the cumulative time series. A specific embodiment of the fitting consists of a number of algorithm steps. One of the algorithm steps consists of a procedure, for example the python numpy linspace function, to map counts of orders onto the (rescaled) time interval x∈[0,1]. Each of these processed customer data sets is fitted with a sigmoid function that may be represented by the formula

$$S ( t ) = \frac{A}{1 + {e}^{- k ( x - {x}_{0} )}} ,$$

where 4 is the amplitude of a cumulative order set, x₀ is the modeled time (an inflection point in a cumulative order set), and k is a modeled rate (a characteristic rate of customer order accumulation). Additionally, a non-linear least squares function is used for a sigmoidal fit for each customer data set.

The sigmoid function is a nonlinear function that describes phenomena that start slowly, accelerate, and saturate at the end, creating an “S”-shape. The sigmoid function is universal for capturing activating and inhibiting decision-making processes in customer ordering activities. It is suited for representing the initial decision of a customer to order, dynamics of orders, and inhibitory patterns that slow the rate of orders and lead to the customer eventually leaving the system. Depending on the duration of a customer's ordering activities up to a particular time (lifespan), the sigmoid predicts the customer's total lifetime even several years before they stop their orders. The output of the sigmoid model fitting algorithm is a complex object which includes fitted time series, inflection time, and the slope. Together these outputs provide a set of new dimensions, a parameterized reduced dimensional space, for comparing customer ordering behaviors. More detailed description of sigmoid curves in this method can be found in the incorporated Document 3 and Document 5.

In a further embodiment of the invention, the parameters provided by the sigmoid function fitting are used in the construction and visualization of a parameter space (see FIG. 10 in Document 4). This visualization of the parameter space is suitable for analysis and modeling of individual customers, collections of customers and the entire set of corporate customers, including a sensitivity analysis of customers at a current period of time, identifying customers with higher and lower buying potential, and similar start times. For marketers it provides an overview of the ordering behaviors of corporate customers for tactical and strategic decisions in customer relations management, and in planning of corporate investments and resources.

In another embodiment of the invention, an interactive visualization system is constructed that incorporates within it plots of customer ordering data, customer sigmoidal fits, customer population parameterized spaces. The visualization system can be provided to at least one of business owners, executives, operational managers and other employees and stakeholders of the corporation.

In another embodiment of the invention, the interactive visualization is further augmented by the display of customer parameterized lifepaths which shows how customers proceed through parameter spaces over time. These paths represent unique customer signatures (lifepaths) that customer activities leave in time. When customer signatures are contrasted by being placed side by side on a single plot, the comparison reveals an aggregate visualization of customer lifepaths, and makes it easy to identify customers with similar or distinguishing characteristics and gain insights about the complexity of customer interactions for tactical and strategic decisions about how to manage customer relations. Moreover, the visualizations reveal trends both at the level of individual customers and at the level of customer segments and entire industries. An example embodiment is shown in incorporated appended Document 4 FIG. 3.

In embodiments of the invention in addition to the use of a sigmoid function and parameterized spaces, the interactive visualization also utilizes other algorithms to facilitate exploration of patterns in the collective view such as point-region quadtree algorithm, correlation analysis, k-means, analysis of scatter plot density, and interactions which yield additional insights about individual customer behavior and signatures in the collective plot. In this embodiment, customer signatures over time may be concisely termed as parameterized lifepaths. Further aspects of the visualization system of collective and individual customer signatures are described in Document 4.

In a specific embodiment of the invention an analytic process uses corporate customer ordering history to generate parameter spaces with each customer as one point in the parameter space, and by showing multiple customers in a parameter space visualization plot revealing the collective behaviors of the customer systems. The invention enables classification of customers in a system based on their number of orders and ordering behavior (see FIG. 1 in Document Document 3). The invention is capable of automatically detecting (or providing visual cues that enable a human operator to more easily detect) when a customer behavior is changing from an activating ordering to an inhibiting one. Depending on the customer's current lifespan, the invention may be able to predict the customer's total lifetime even several years before they leave.

An approach of the invention is to identify universal behaviors, and a specific embodiment makes use of analysis that validates a universal behavior of customer ordering over time. The initial decision of a customer to order starts an activating pattern that self-reinforces over time. However, due to internal or external constraints, an inhibitory pattern may begin to dominate and slow the rate of orders and lead to the customers eventually leaving the system. The combination of activating and inhibiting decision-making processes generates a specific ordering curve for each customer. The sigmoid curve is a nonlinear function that describes phenomena that start slowly, accelerate, and saturate at the end, creating an “S”-shape (see FIG. 1 in Document 3). The invention considers that the sigmoid function is useful for analyzing customers ordering behavior because of its universality across multiple customers, corporations and industries.

The universal nature of the sigmoidal function for customer ordering behavior can be further generalized to the case of any behavior that has a beginning and an end. This includes authors writing books, actors appearing in plays, scientists writing scientific articles, epidemic disease spreading, widespread news article reading, inventors creating inventions, companies producing products, companies producing particular goods or providing particular services, and mothers giving birth to children. The wide range of applications of the sigmoidal function as a universal process can be utilized for analytic methods that support decision making processes in economic activity including but not limited to corporate sales, and attracting attention for economic benefits.

An approach of the invention makes use of a characterization of the ordering behavior of customers by labeling them by a universal representation with only a few parameters. The few parameter representation comprising a dimensional reduction of attributes of individual customers of the population. The universal labeling may be augmented by identifiers including industry, geographic region, and type of product or products being bought.

An approach of the invention makes use of a labeling of regions of the few dimensional parameter space, the labels comprising a dimensionally reduced representation of individual customers of the population. The labeling of regions may be augmented by identifiers including industry, geographic region, and type of product or products being bought.

An approach of the invention makes use of a visualization of the few dimensional parameter space, with points in the parameter space representing individual customers. The visualization providing ability to display only part of the parameter space, and only a subcategory of inventory items according to identifiers including period of time, industry, geographic region, and type of product or products being bought.

An approach of the invention makes use of a visualization of a few dimensional parameter space, with points in the parameter space representing individual customers, juxtaposed with details of the behavior of individual customers items including the dynamics of orders and the fitted dynamics of the orders by a universal representation. The visualization further providing an interactive ability for an operator to select which customer details are being displayed for, the methods for selection including, but not limited to, searches over customer labels, or using a pointer device to select a point in the reduced parameter space.

An approach of the invention makes use of a labeling obtained from an analysis of customer ordering dynamics, this labeling being a dimensional reduction of the ordering behavior, the differences between the labels being indicators of types of behavior that are relevant to the identification of actions by an individual or corporation that is making use of the method, the actions being either automated or manual, the identification of the action being understood from a visualization, equation, report or prompt resulting from the application of a General Method or given by a Specific Method of the invention.

An approach of the invention makes use of a characterization of the ordering behavior of customers by labeling them by a universal representation with only a few parameters. A mapping of the customer behavior reduced representation onto the parameter space, so that each point of the parameter space represents a single customer, providing a map of the entire set of customers of the corporation, or a subset of the entire set of customers of the corporation. The universal labeling may be augmented by identifiers including industry, geographic region, and type of product or products being bought.

An approach of the invention makes use of further algorithms to obtain a dimensionally reduced characterization of the population in the form of distributions of the customers, and parameters that characterize the distribution yielding a parameterized dimensional reduced representation of the population. The distribution being a density of the population in the reduced dimensional space, or according to measures of aggregate ordering history. The labeling of the customer distributions may be separated by segments of the customer population according to identifiers including industry, geographic region, and type of product or products being bought.

An approach of the invention makes use of a parameterized dimensionally reduced characterization of the population of customers the differences between the parameter values, or labeled regions of the parameter space, being indicators of types of behavior that are relevant to the identification of actions by an individual or corporation that is making use of the method, the actions being either automated or manual, the identification of the action being understood from a visualization, equation, report or prompt resulting from the application of a general method or given by a specific method of the invention.

### Part III: Embodiments on the Topic of Inventory Management

Embodiments of the invention provide multiple methods to improve inventory management by applying algorithms to data that improve the accuracy of inventory estimates, thus improving inventory level management, order fulfillment, as well as right size and timely production scheduling. Historical inventory record data is used for analysis of inventory, and of the system of inventory management, for detection of the sources and potentially large cumulative effects of small errors. Inaccurate information about available inventory combines with the difficulty of forecasting future orders to impose extra costs due to excess inventory and lost ability to fulfill orders due to insufficient inventory that leads to stock outs. In contrast to the challenges imposed by limited ability to forecast orders, the inaccuracy of inventory information can be addressed by multiple techniques that improve the internal record keeping including implementation of smart identifiers to inventory items. However, such techniques are only feasible in particular cases and may cause an operational bottleneck that can slow down the speed of the material flow in the supply chain system.

In a particular embodiment of the invention algorithms are applied to detailed historical inventory event records to correct errors and precisely calculate current inventory levels. The historical inventory data can be extremely useful for analysis of the system and for detection of the sources and effects of small errors. This precise high resolution processing of inventory records can increase computational efforts. However, computational resources are generally inexpensive compared to the costs resulting from excess inventory and stock outs. These methods can reduce costs, increase customer satisfaction, provide competitive advantage, and increase revenue.

An embodiment of the invention detects errors through applying algorithms to inventory records and comparing multiple electronic records associated with inventory changing or counting events. Underlying the algorithms is the detection of logical inconsistencies between multiple electronic records enabling error correction protocols. In standard methods for event processing, the accumulation of multiple errors, such as the difference between a factory's internal shipments and excess pulled inventory, can lead to reported negative on-hand inventory when positive on-hand inventory exists, or to result in unnecessarily high on-hand inventory when unnecessary orders are placed or finished good production runs are made. Identification of the sources of errors can help prevent them, saving the time and cost of numerous cycle counts, as well as other costs and management inefficiencies caused by inaccurate inventory levels.

An embodiment of the invention includes a method for inventory level calculation using comprehensive event analysis (see FIG. 3. in Document 6). Historical corporate electronic data, though difficult to work with, contains rich ancillary details capable of providing highly accurate inventory records. Results of a reduction to practice applied to an industrial corporation indicate that comprehensive event analysis can harness the details in historical data to consistently yield accurate inventory records, as well as to identify the causes of errors (see FIG. 5. in Document 6). The invention provides information that can be used to take actions that change inventory management practices so as to prevent errors, saving the time and cost of numerous cycle counts and other costs and management inefficiencies caused by inaccurate inventory records.

In a specific embodiment of the invention the dynamics of discrepancies in the inventory level data of a mid-sized industrial production facility with almost twenty years of inventory data were characterized. The invention uses a hybrid method to calculate the inventory levels, the method takes advantage of all historical data for accurate estimation of available material in the inventory at any time during the past 20 years. The results were compared with the inventory levels calculated using conventional event-based methods to identify the discrepancies and possible sources of the errors. FIG. 7 in Document 6 provides a comparison of the cumulative quantities of inventory levels as calculated by the method of the invention with the conventional record based method. The difference between Method 1 and Method 2 for the Internal-Transfer Received indicates a significant source of discrepancy which indicates a persistent error in the internal shipments data. The invention substantially enables correction of inventory errors both as a real time processing method, and as a guide to improvements for inventory management and record keeping practices.

An embodiment of the invention consists of a system that performs multiple algorithms applied to electronic inventory records in two stages, data cleaning methods and data analytic methods. The data cleaning methods include multiple rounds of grouping and identification of inventory changing or recording events. These methods further incorporate both of two types of records; the first type of records consists of quantitative and categorical records, and the second type of records consists of narrative, descriptive or unstructured records. Historical inventory databases may include many details of the supply chain in a descriptive or unstructured format in addition to the event records that are more readily analyzed with computational algorithms as they are typically marked using quantitative predefined categories with limited details. Some events may, however, be marked as an unknown category, and for these records and others, details are available in descriptive fields. Methods of the invention take advantage of the descriptive details of the events in the historical databases. These details improve inventory level estimations by correcting multiple sources of errors, and identify the sources of recurrent errors, which are not detected using the conventional inventory level estimation methods. Combining both types of structured and unstructured records, the system of this invention targets the discrepancies in the data and identifies the sources of the accumulating errors at the large scale.

In a first set of embodiments of the invention applied to inventory calculations, which are close to but not equivalent to the standard methods, an event-based method calculates raw material inventory (I) via the daily accumulation of the receiving raw material (R), consumption of material (C), shipped material (S) and rejected material (J) of each item in the inventory at each warehouse (w). Equation (??) determines I at any time t using a recursive formula

$${I}_{w , i} = {I}_{w , t - l} + {\sum }_{e = 1}^{{n}_{t}} ( {R}_{e , t} - {C}_{e , t} - {S}_{e , t} + {J}_{e , t} ) \qquad ( 2 )$$

wherein e is the event and nₜ is the number of events at time t. The value of I at t=0 is derived from the physical count closest but prior to the date of interest. FIG. 2 in Document 8 is a schematic of this method. Further information is found in Document 9.

In a second set of embodiments of the invention applied to inventory calculation, multiple historical data records are combined together to provide estimates of inventory. Historical data is formatted as a single table containing the data for all years of activity and logs of all minor and major events. Historical data tables accumulate various kinds of information including events, inventory counts, and other industrial details. Algorithms are applied to the table to correct it for duplicate records, incorrect inputs due to human error, and unspecified event types. The algorithms systematically prune extraneous records and correct a variety of types of errors and discrepancies. Further algorithms of the method use the narrative and unstructured description fields to identify cycle counts and physical counts to enable variance calculations and error corrections after cycle counts and physical counts of the inventory as reported in the inventory records. FIG. 3 in Document 6 is a schematic of the method. Additional information is found in Document 7.

In an embodiment of the invention, algorithms are applied to filter ambiguous data and unreconciled details to remove extraneous records. The pre-processed data is aggregated by classes with each item in each class processed separately. The results are aggregated into groups based on items, dates, and warehouses. Methods and algorithms are applied to determine re-classifications of inventory items. Methods and algorithms are applied to obtain the daily quantity for each item in each warehouse. Finally, the accurate inventory calculation of events as it is identified from historical data is compared with the event tables to identify the sources of discrepancies.

An approach of the invention improves on conventional methods that disregard what are considered minor errors and variances (such as shipment quantity variances) and re-classifications of the inventory items. In contrast, the invented method incorporates many of the conventionally neglected “minor” events that change inventory. An approach of the invention also includes the information from cycle counts and physical counts whenever they happen. An approach of the invention is to calculate the inventory levels using multiple methods. The differences in inventory levels calculated using different methods enables identifying errors that occur in electronic logs as well as the possible causes of errors, their frequency, and potential for pre-dieting and correcting the errors causing the discrepancies.

As an embodiment of the invention and its reduction to practice, we conducted a study on almost 20 years of historical inventory data of a medium-size company. The data included detailed supply-chain information covering purchase orders, raw material pulls, customer orders, invoice tables, cycle and physical counts, internal and external shipments, and variances tables. In order to demonstrate the effectiveness of the invention we provided comparisons of the results of the invented method and methods similar to those used conventionally. In particular, we calculated inventory levels using multiple embodiments of the invention, both those that are close to conventional methods, proceeding through incorporating methods of the invention, as well as implementations that incorporate multiple methods of the invention.

The errors in the conventional method (Method 1) and invented method (Method 2) were then calculated for the purpose of comparison. Since Method 1 is a recursive calculation, random errors accumulate as time goes on. If the errors are stochastic without a bias, they are expected to add and subtract randomly over time according to a generalized random walk and satisfy the central limit theorem. The magnitude of errors in this case (E_{R}) grows with the square root of time:

$${E}_{R} ( t ) \sim {t}^{\frac{1}{2}} \qquad ( 3 )$$

In many instances there will be a bias toward either positive or negative values due to the characteristics of errors that are taking place. In this case on average the error accumulates linearly in time, with variations occurring around the average:

E_{B(t)˜t} (4)

While linear growth is nominally more rapid than square root growth, either square root or linear growth can lead to dramatic deviations of inventory levels. Inventory counts are performed to correct errors. Method 2, by including physical inventory count as events, periodically re-calibrates, and errors do not accumulate over times longer than the intervals between counts. Errors still exist due to the accumulation of errors that occur between counts. There is also a possibility of errors taking place in the count or its recording. These errors, however, do not accumulate over longer times as they can be expected to be reset by the subsequent count. The errors are therefore independent of time:

E_{C}(t)˜t (5)

The analysis shows that the distinction between time independent errors and errors that accumulate, giving expected magnitudes that increase in time, is a significant distinction for inventory accuracy.

Since right after physical counts, the on-hand inventory levels for the second class of methods are at their lowest expected error, it is possible to estimate the error levels for both methods. The error for the second class of methods is calculated by comparing the inventory level just before and after a count. This would include both errors that accumulated between counts and the errors of a count. Similarly, the error for the first class of methods is calculated by comparing the inventory level of the second class of methods and the first class of methods after the physical count events.

More precisely it can be shown that the error values obtained for the second class of methods by subtracting before and after values (E_{AB}) satisfies the equation

E_{AB}=\sqrt{Eₐ+2E_{q}} (6)

where E_{q} is the expected error of a count, and Eₐ is the expected error that accumulated between counts. A factor of 2 appears because of errors occurring either in the previous or current count.

In embodiments of the invention inventory characterization algorithms input estimated inventory levels, following error detection and correction, and output estimates of an additional set of measures that are useful for insights into the inventory dynamics including but not limited to, accurate demand levels, material turnover, excess inventory and the ratio of the number of orders versus consumption quantity for each type of material.

Embodiments of the invention include an interactive visualization platform, the visualization platform incorporating algorithms that receive as input estimated inventory levels, and calculations of estimates of other measures, which are presented by the visualization platform in dynamic plots and parameter space figures. The visualization represents each inventory item's level at different temporal resolutions, such that it is possible to compare multiple analytical properties of the inventory. Individual inventory items, in different periods of time, are shown as individual dots in a figure that shows their characteristic properties as an entire population, or as a subset of the entire population determined by relevant industrial categories or quantitative thresholds that are dynamically chosen. The visualizations provide interactive controls and the results can be exported in different data formats. The interactive visualization platform provides essential information for inventory management and makes it observable to business owners, executives, operational managers and other employees and stakeholders of the corporation. Additional information is found in Document 10.

An approach of the invention makes use of a characterization of dynamics of inventory items by labeling the dynamic behavior by a reduced dimensional representation having only a few parameters during a particular period of time.

In an embodiment of the invention the parameters characterizing an inventory item may include monthly and yearly average, minimum and maximum inventory-level, volume, turnover, consumption, pull frequency divided by order frequency (S/P), minimum inventory-level divided by volume, minimum days of remaining inventory based on inventory-level and consumption rate and, minimum inventory divided by average inventory. The few parameter representation comprising a dimensional reduction of attributes of individual inventory item dynamics during a specified period of time. The inventory item labeling may be augmented by identifiers including whether the inventory item is a raw material or finished good, subcategory of inventory item according to function or industrial process, industry, geographic region, and type of product or products being made.

An approach of the invention makes use of a labeling of regions of the few dimensional parameter space, the labels further comprising a dimensionally reduced representation of specific inventory items. The inventory item labeling may be augmented by identifiers including whether the inventory item is a raw material or finished good, subcategory of inventory item according to function of industrial process, industry, geographic region, and type of product or products being made.

An approach of the invention makes use of a visualization of the few dimensional parameter space, with points in the parameter space representing individual inventory items during a particular period of time. The visualization provides ability to filter out and display only part of the parameter space, and only a subcategory of inventory items according to identifiers including whether the inventory item is a raw material or finished good, subcategory of inventory item according to function or industrial process, industry, geographic region, and type of product or products being made.

An approach of the invention makes use of a visualization of the few-dimensional parameter space, with points in the parameter space representing individual inventory items during a particular period of time, juxtaposed with details of the behavior of individual inventory items including the dynamics of inventory levels, the times of ordering and pulling of inventory, the times of stock outs, the turn rates during a specified period of time, and averages over specified intervals of time of such details of individual inventory item behavior. The visualization further provides an interactive ability for the operator to select which inventory item details are being displayed for, the methods for selection includes, but are not limited to, searches over item labels, or using a pointer device to select a point in the reduced parameter space.

An approach of the invention makes use of a labeling obtained from an analysis of inventory items, this labeling being a dimensional reduction of the inventory behavior, the differences between the labels being indicators of types of behavior that are relevant to the identification of actions by an individual or corporation that is making use of the method, the actions including, for example, the decision of increasing or decreasing ordering or production rates, increasing or decreasing safety stock, or changing inventory or product mix, the actions being either automated or manual, the identification of the action being understood from a visualization, equation, report or prompt resulting from the application of a general method or given by a specific method of the invention.

An approach of the invention makes use of a characterization of the inventory items by labeling them by a representation with only a few parameters. A mapping of the inventory items reduced representation onto the parameter spaces, so that each point of the parameter space represents a single inventory item, providing a map of the entire set of customers of the corporation, or a subset of the entire set of inventory items of the corporation. The inventory item labeling may be augmented by identifiers including whether the inventory item is a raw material or finished good, subcategory of inventory item according to function or industrial process, industry, geographic region, and type of product or products being made.

An approach of the invention makes use of further algorithms to obtain a dimensionally reduced characterization of the population in the form of distributions of the inventory items, and parameters that characterize the distribution yielding a parameterized dimensional reduced representation of the population. The distribution being a density of the population in the reduced dimensional space, or according to inventory dynamics history. The labeling of the inventory distributions may be separated by segments of the inventory items according to identifiers including whether the inventory item is a raw material or finished good, a subcategory of inventory item according to function or industrial process, industry, geographic region, and type of product or products being made.

An approach of the invention makes use of a parameterized dimensionally reduced characterization of the population of inventory items the differences between the parameter values, or labeled regions of the parameter space, being indicators of types of behavior that are relevant to the identification of actions by an individual or corporation that is making use of the method, the actions being either automated or manual, the identification of the action being understood from a visualization, equation, report or prompt resulting from the application of a general method or given by a specific method of the invention.

### Part IV: Embodiments on the Topic of Shipping Management

An embodiment of the invention takes customer data as input and produces a characterization of customers according to a parameter space including two variables that are important for algorithms for shipment optimization; the first parameter space coordinate is the distance of the most used shipment route from the customer to the production facility and the second parameter space coordinate is the estimated average customer demand frequency. The demand frequency is the ratio of the total quantity ordered by the customer to the customer life span using historical corporate data.

An embodiment of the invention provides a descriptive characterization of customers, the “customer space,” an example of which is shown in FIG. 1 in the appended and incorporated Document 8. Each customer is characterized by two variables: the distance of the most used shipment route from the customer to the production facility and the customer demand frequency. The demand frequency is the ratio of the total quantity ordered by the customer to customer life span using historical corporate data. The expected relationship between these two variables and the choice of shipment strategies can be determined by the invention both by observed semi-quantitative factors and by quantitative calculation.

The method makes apparent through data analysis and visualization that there is a robust determination of optimal shipping method according to the observation that:
The direct strategy is most effective for (1) customers close to production facilities, regardless of demand frequency, or (2) customers who order rarely, regardless of distance, as illustrated by the blue region in Document 8 FIG. 1 (bottom panel). For close customers, maintaining an external warehouse is unnecessary given that the proximity of customers ensures rapid delivery. For low demand customers, the uncertainty of order arrivals makes it inefficient to plan ahead, and shipping directly is a practical solution.
The indirect strategy becomes optimal when the customer's distance to production facilities is far and orders are frequent above a certain level, as illustrated by the green region in Document 8 FIG. 1 (bottom). When both demand and distance are large enough, the certainty of ordering behavior supports the replenishment of inventory in external facilities before the customer even places the next order. Cheaper, slower transportation alternatives are possible between production facilities and external warehouses. When the customer places the next order, the goods will already be at the external warehouse and can be rapidly delivered to the customer. This indirect strategy may reduce transportation-associated costs while preserving or even improving customer satisfaction.
The best strategy for customers with intermediate distance and intermediate demand will depend upon details of the freight and storage cost information, as illustrated by the yellow region in Document 8 FIG. 1 (bottom).

In one embodiment of the invention the optimal delivery method is determined between two strategies, direct or indirect. The direct and indirect strategies consist of shipment from a company production facility to a customer facility, and from a company production facility to a company or other warehouse before shipment to the customer. In the embodiment of the invention the determination of optimal strategy for an individual customer is evaluated by a mathematical optimization model that includes costs of shipment and storage. The methods were developed and applied as a reduction into practice using the historical data of a medium-sized corporation. The shipment strategies and optimization methods are further described in the appended and incorporated paper (Document 8).

In one embodiment of the invention methods take existing locations of warehouses and determine locations for the addition of new warehouses. To identify the optimal locations of warehouses that robustly minimize the freight cost across all customers the embodiment used k-means algorithm, possibly weighted based on the overall amount of demands by customers shipped from a warehouse. The methods of warehouse location optimization are further described in section 2.3 of the appended and incorporated Document 8.

In one embodiment of the invention shipping and storage costs are minimized by optimizing route costs including the possibility of adding new warehouses. We optimized routing costs by including the locations of additional warehouses added through the use of k-means algorithms and incorporating storage costs and transportation costs.

In one embodiment of the invention, algorithms and a data-analysis process are used to optimize freight and storage costs. The algorithms and analysis can determine the optimal shipping methods for individual customers and identify the optimal number and locations of storage facilities. These analyses do not rely on preexisting assumptions about customer behavior and logistics, which are instead derived from the historical electronic data.

A specific embodiment of the invention makes use of distances from the production facilities to customer locations and frequency of customer orders to determine the optimal way to deliver goods to the customer (see FIG. 2 in Document, 8). Additionally, the algorithms optimize the storage facilities' locations in order to save time on freight and storage costs (see FIG. 6 in ibid.). The invention was used in reduction to practice to develop a logistics model for a medium-sized manufacturing company based on historical shipping and warehouse data. The method yielded 10-15% savings on yearly transportation and storage costs and an additional 4.6% savings on optimizing the locations of storage facilities. The method of the invention is a new approach to optimizing business operating costs.

A specific method of the invention determines the optimal storage and transportation strategy for each customer starting from a model of the costs of shipment and storage to determine between direct and indirect strategies. Which of the strategies is optimal depends on the direct delivery time and on analysis of cost of shipment and storage. The method defines the direct delivery time as the time between the shipment of a good and its delivery to the customer. Constraints on the optimization can be implemented through parameters in the algorithm according to corporate policies. In the reduction to practice, the corporate policy implemented constrained the maximum delivery time for goods to two days to ensure customer satisfaction. Delivery time was calculated using truck speeds of 70 miles per hour and 8 hours of driving per day and rail car speeds of 49 miles per hour and 24 hours of travel per day. If the time of direct delivery is more than two days, adequate customer satisfaction requires using the indirect strategy as an imposed constraint.

In a method of the invention an algorithm of the method evaluates the costs of the direct and indirect strategies and includes a production facility (P), external warehouse (W), and customer (C). The potential costs include c_{d}, the cost of shipment from P to C; c_{w}, the cost of shipment from P to W; cₛ, the cost of storage at W; and cₒ, the cost of shipment from W to C. The freight costs c_{d}, c_{w}, or cₒ must, also be multiplied by the number of shipments n_{d}, n_{w}, or nₒ, respectively. The number of shipments depends on the demand from the customer. The customer's expected demand over a year is estimated to be the demand frequency multiplied by the days in a year. We considered the number of shipments in a year to be the ratio of total demand to the shipment carrying capacity of trucks and rail cars. The cost J for a given strategy π is then determined for the direct strategy as J(π_{d})=n_{d}c_{d}, and the indirect strategy as J(π_{w})=n_{w}c_{w}+cₛ+nₒcₒ.

In a method of the invention an algorithm of the method includes various parameters that determine storage and freight costs. In the reduction to practice costs were directly based upon detailed descriptions of those costs that vary between shippers and warehouses. The storage cost cₛ, depends on: (1) the storage facility type s, (2) the quantity that is stored q (inventory cost), (3) the time the quantity is stored t, and (4) loading u and unloading w events, giving cₛ=S(s,q,t,u,w). The freight cost c_{f}∈{c_{d},c_{w},cₒ} depends on: (1) the carrier type s′, (2) the distance the goods are sent d, and (3) the quantity of the goods q′, giving the relationship c_{f}=F(s′,d,q′). In order to calculate actual cost based upon the company data, we extracted existing routes along with their associated distances from historical data and incorporated specific storage costs.

In a method of the invention an algorithm calculates savings of costs due to use of optimal strategies. Each customer i has an optimal shipping cost, designated Cᵢ which also includes storage costs if present. Each customer has a current shipment route (designated route 0), which has a known cost C0ᵢ. We then independently calculated the lowest cost router (designated router 1), which has a cost C1ᵢ. We calculated C1ᵢ by examining nearest warehouses and incorporating storage costs and transportation costs. Finally, we compared the current cost to our calculated costs, and if C1ᵢ<C0ᵢ, then the preferred cost, Cᵢ, equals C1ᵢ, otherwise Cᵢ=C0 ᵢ. From this, we calculated total percent savings (S) for all customers as a percentage: S=100*(1−(ΣᵢCᵢ)/(ΣᵢC0ᵢ).

In an embodiment of the invention the methods incorporate algorithms that optimize the locations of additional warehouses making use of determination of the changes in costs of those additional warehouses. In the reduction to practice, aside from the existing corporate warehouses and external warehouses used by the corporation in locations where they did not have corporate warehouses, we identified prospective locations for new warehouses for additional savings. In order to determine potential locations, we used the k-means algorithm to find the optimum locations for the warehouses that best match the locations of customers to minimize the freight cost across all customers. Freight cost C_{f} is a function of euclidean distance dᵢⱼ between customers (i) and warehouses (j). It is weighted based on the overall amount of demands by customers shipped from a warehouse, Dᵢⱼ.

$$Minimize {C}_{f} = {\sum }_{i = 1}^{N} {\sum }_{j = 1}^{M} {A}_{ij} {x}_{ij} \qquad ( 7 )$$

$${A}_{ij} = {F}^{p} \times R \times {D}_{ij} \times {d}_{ij}$$

$${d}_{ij} = ‖ {w}_{j} - {c}_{i} ‖$$

$$Subject to {x}_{ij} ∈ \{ 0 , 1 \} , ∀ i = \{ 1 , … , N \} , j = \{ 1 , … , M \} \qquad ( 8 )$$

$${\sum }_{i = 1}^{N} {x}_{ij} = 1 , ∀ j = \{ 1 , … , M \} \qquad ( 9 )$$

where N and M are the number of customers and warehouses. In the calculation of dᵢⱼ, cᵢ and wⱼ refer to the geographical location of customers and warehouses, respectively. The variable xᵢⱼ equals to 1 if customer i is served by warehouse j and it equals 0 if it is not. Eq. ?? indicates that each customer is only connected to one warehouse. We assigned customer demand weights according to Wᵢ=┌Σₖ₌₀ⁿ^{ᵢ}Qₖ/Q₀┐, where nᵢ is the number of orders by customer i, Qₖ is the quantity of order k by customer i, and Q₀ is an industry standard measure for a significant customer volume. The brackets ┌x┐=ceil(x) indicates the smallest integer greater than x. In fact, Q₀ corresponds to the average shipment size by standard vehicles. So, Dᵢⱼ=Wᵢ if xᵢⱼ=1; otherwise it is 0. Here, F^{P} refers to fuel price and R refers to average fuel consumption rate by vehicles. For simplicity, we considered one type of vehicle with a fixed shipment size.

In an embodiment of the invention the k-means algorithm is used to aggregate the customer locations into & disjoint groups or clusters and find a centroid Cₖ for each group to minimize the average squared distance between the centroid and customer locations within each group. To consider the weight of customer demands, we assigned Wᵢ points to the location of each customer i. The number of groups to be found is a parameter of the analysis. The algorithm is an iterative refinement technique that starts from random locations for centroids and updates the location of centroids in each iteration until reaching an optimum location for all the centroids. The method considers the centroid to be an approximate optimum location for a warehouse assigned to the customers of a group. The freight cost from warehouses to customers inside the groups decreases as the number of centroids increases and slowly converges to zero. The method determines the optimum number of centroids from the deceleration in the freight cost. The method compares the location of currently active warehouses with the location of centroids, identifying the best locations for the additional warehouses to decrease the transportation costs. The k-means analysis dramatically reduces the number of candidate locations to be considered for cost optimization.

In an embodiment of the invention the method of calculation of optimal shipping strategy and costs incorporates new warehouse locations proposed by the method of analysis. Since the storage cost of a hypothetical warehouse is unknown, representative estimates of the costs can be used (high, medium and low) based on existing warehouses to model storage costs for the proposed warehouses.

It is An approach of the invention to provide characterizations of customers by a reduced dimensional parameter space, in which points represent individual customers, and where distinctions in the location of the reduced dimensional space between point locations are relevant to customer shipping methods, segment the reduced dimensional space into regions, label those regions, and provide algorithms and visualizations of the reduced dimensional parameter space, juxtaposed with data about or plots of details of individual customers, labeled regions of the parameter space, and output of the algorithms, being indicators of types of behavior that are relevant to the identification of actions by an individual or corporation that is making use of the method, the actions being either automated or manual, the identification of the action being understood from a visualization, equation, report or prompt resulting from the application of a general method or given by a specific method of the invention.

### Part V: Embodiment on the Topic of Determining “Functional and Social Team Dynamics in Industrial Settings”

In an embodiment of the invention algorithms analyze the properties of human interaction networks. A specific embodiment and reduction to practice analyzes an internal corporate interaction network. Like other social systems, corporations comprise networks of individuals that share information and create inter-dependencies among their actions. The properties of these networks are crucial to a corporation's success. However, the analysis of these properties is a challenge for managers and management software developers looking for ways to enhance corporate performance. Understanding how individuals aggregate into teams, and how teams form corporations, is essential to maintaining cohesion and improving performance at scale. Team communication can be considered to fall into two categories: functional and social communication. Understanding the function and interplay of these two channels is essential to understanding what makes a team cohesive and more productive.

In an embodiment of the inventions a method and algorithms is used to identify the directed organization and self-organization of individuals into teams and the way the team structure relates to performance is determined. In the reduction to practice, we analyzed functional and social communication networks from industrial production plants and related their properties to performance. We used internal management software data that reveals aspects of functional and social communications among workers. We identified the assortativity of both the functional and social communications. We found negative degree assortativity in functional communication which indicates asymmetry of interaction and positive job-title (i.e. executives, managers, supervisors, and operators) assortativity in social communication which indicates segregation by role. We showed that the asymmetrical structure of functional communication networks exerts more influence on performance than the segregated structure observed during social communication. We showed that the density of social communication networks is relevant to improving performance.

An approach of the invention provides characterizations of individuals and the groups and types of communication networks they participate in using a reduced dimensional space, in which points represent individuals, groups or subnetworks, and where distinctions in the location of the reduced dimensional space between point locations are relevant to characterizing individual and group behavior, and provide algorithms and visualizations of the reduced dimensional space, juxtaposed with data about or plots of details of individuals, groups or subnetworks, and output of the algorithms, being indicators of types of behavior that are relevant to the identification of actions by an individual or corporation that is making use of the method, the actions being either automated or manual, the identification of the action being understood from a visualization, equation, report or prompt resulting from the application of a general method or given by a specific method of the invention. Additional information is found in Document 11.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

Finally, it is expressly contemplated that any of the processes or steps described herein may be combined, eliminated, or reordered. Accordingly, this description is meant to be taken only by way of example, and not to otherwise limit the scope of this invention.

### SUPPLEMENTARY MATERIAL INCORPORATED HEREIN

The supplementary materials incorporated fully by reference in this application are of record as filed with the priority U.S. Prov. Pat. App. Ser. No. 62/912,288. The list of the supplementary material are as follows:
Document 1: Global patterns of social fragmentation
Document 2: Social fragmentation at multiple scales
Document 3: Universal dynamics of customer acquisition and retention
Document 4: Parametrized lifepaths: towards a complex system representation of lifelines;
Document 5: Customer behaviors and dynamics;
Document 6: Investigating dynamics of inventory discrepancies using historical data: a case study;
Document 7: Analysis of DH corporation inventory management;
Document 8: Freight cost optimization in logistics network with limited strategies;
Document 9: Transportation and warehouse inventory optimization;
Document 10: Visualization guide;
Document 11: Functional and social team dynamics in industrial settings.

1. A system, comprising:
a computing device configured to obtain a plurality of vectors comprising data from a data stream;
a network detection module installed on the computing device and configuring the computing device to identify a set of networked geospatial communities determined from the data from the data stream;
a partitioning module installed on the computing device and configuring the computing device to partition the geographical space into a plurality of regions, each region containing a subset of network relationships; and
an output module installed on the computing device and configuring the computing device to:
based on an identification of the corresponding subset of network relationships contained in a first region of the plurality of regions, identify one or more actions to be performed; and
transmit one or more messages to one or both of an automated system and a system user, the one or more messages being associated with the one or more actions.

2. The system of claim 1, wherein the partitioning module is further configured to associate a label with each of the plurality of regions, the label identifying a data derived characteristic of each of the plurality of regions.

3. The system of claim 1, wherein the partitioning module causes the computing device to partition the geographical space into a multiscale hierarchy of geospatial regions as the plurality of regions, with smaller and larger regions.

4. The system of claim 3, wherein: the partitioning module is further configured to associate a labeling scheme for the multiscale hierarchy, the labels identifying a data derived characteristic of each of the plurality of regions.

5. The system of claim 3, wherein the output module is further configured to output the geospatial regions.

6. The system of claim 1, further comprising an input module interfacing with the computing device and configured to input into the partitioning module a description of a set of partitions or partition labels.

7. The system of claim 1, wherein the computing device is further configured to obtain new data not previously included in the data streams, the system further comprising an identification module installed on the computing device and configuring the computing device to identify which member of the set of regions to associate to the new data.

8. The system of claim 1, wherein;
the network detection module further configures the computing device to obtain a multiscale fragmentation map that shows collective behaviors of people constructed from relationships between them that arise in communications or transactions described in the data streams; and
the partitioning module further configures the computing device to aggregate locations of the people geographically into corresponding groups by linking each location to a hierarchical partitioned, geographical grid comprising at least three hierarchical levels.

9. The system of claim 8, wherein the network detection module is configured to produce the multiscale fragmentation map using a community detection algorithm comprising one of Louvain, spin glass, and infomap.

10. The system of claim 1, wherein the network detection module is configured to apply a community detection algorithm to the plurality of vectors to produce a multiscale fragmentation map comprising the set of networked geospatial communities, the community detection algorithm comprising one of Louvain, spin glass, and infomap.

11. The system of claim 10, wherein the partitioning module further configures the computing device to map, using a partitioning algorithm, each of the plurality of vectors to a corresponding reduced vector to generate a map of communities at multiple scales.

12. The system of claim 11, wherein the partitioning module further configures the computing device to map a continuum of values onto the set of networked geospatial communities, the continuum setting a corresponding value for each of a plurality of social media users who are a part of a first community, of the set of networked geospatial communities, that is determined by location and social interactions.

13. The system of claim 11, wherein the network detection module further configures the computing device to map, with a community detection algorithm, each grouped edge of a plurality of grouped edges detected in the plurality of vectors, onto a corresponding reduced geospatial grid of multiple scales.

14.-24. (canceled)

25. The system of claim 1, wherein the computing device is configured to obtain the plurality of vectors having a first number of dimensions, the system further comprising a dimensional reduction module installed on the computing device and configuring the computing device to:
generate a low dimensional space defined by a second number of reduced dimensions determined from the plurality of vectors, the second number being less than the first number;
obtain a plurality of reduced vectors, each reduced vector of the plurality of reduced vectors:
having a corresponding vector of the plurality of vectors; and
having a plurality of values each associated with a corresponding reduced dimension of the plurality of reduced dimensions, and each obtained by applying a dimensional reduction algorithm to the data of the corresponding vector; and
using the corresponding plurality of values of each of the plurality of reduced vectors, map the plurality of reduced vectors onto the low dimensional space to produce a first mapping, the partitioning module using the first mapping to determine the plurality of regions.

26. The system of claim 25, wherein the dimensional reduction algorithm is a sigmoid model fitting algorithm that outputs a complex object which includes a fitted time series, an inflection time, and a slope corresponding to the data, and wherein the dimensional reduction module determines the second number of reduced dimensions and an association of the dimensions to the reduced dimensions based on the complex object.

27. The system of claim 26, wherein the partitioning module includes a partitioning algorithm to identify the regions corresponding to similar behaviors, the partitioning algorithm being one of k-means, hierarchical clustering, density segmentation, and regression.

28. The system of claim 1, wherein the partitioning module further configures the computing device to map, using a partitioning algorithm, each of the plurality of vectors to a corresponding reduced vector to generate the set of networked geospatial communities.

29. The system of claim 1, wherein the partitioning module further configures the computing device to map a continuum of values onto the set of networked geospatial communities, the continuum setting a corresponding value for each of a plurality of social media users who are a part of a first community of the set of networked geospatial communities.

30. The system of claim 1, wherein the network detection module further configures the computing device to map, with a community detection algorithm, each grouped edge of a plurality of grouped edges detected in the plurality of vectors, onto a corresponding reduced geospatial grid of multiple scales.
